(19) United States
(12) Patent Application Publication
(10) Pub. No.: US 2009/0277052 A1
(43) Pub. Date: Nov. 12, 2009

(54) Fastener that is combined with and detached from a name plate and a hanging strap easily and quickly

(76) Inventor: Chin-Yuan Chang, Changhua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/115,694

(22) Filed: May 6, 2008

(51) Int. Cl. G09F 3/14; A44C 3/00

(52) U.S. Cl. 40/1.6; 24/129 R; 40/663; 24/3.4

(57) ABSTRACT

A fastener includes a stop portion, at least one insertion portion mounted on the stop portion and provided with at least one clamping slot, and at least one recessed retaining portion located between the stop portion and the insertion portion. Thus, the insertion portion of the fastener extends through each of the mounting holes of a name plate, and each of the distal ends of a hanging strap extends through the clamping slot of the insertion portion, so that the fastener is combined with and detached from the name plate and the hanging strap easily and quickly. In addition, the hanging strap is movable in the clamping slot of the insertion portion to adjust a distance between the hanging strap and the name plate so as to fit a user's stature and requirement.

### BACKGROUND OF THE INVENTION

1. Field of the Invention

The present invention relates to a fastener and, more particularly, to a fastener for a name plate.

2. Description of the Related Art

A conventional name plate assembly in accordance with the prior art shown in FIG. 26 comprises a name plate 40 and a hanging strap 10. The name plate 40 is provided with two mounting holes 41 spaced from each other and a mounting slot 42 located between the two mounting holes 41. The hanging strap 10 has a first end provided with a mounting loop 11, a mediate portion provided with a sliding ball 12 and a binding portion 13 and a second end provided with a clip 14. The clip 14 of the hanging strap 10 is locked onto the mounting slot 42 of the name plate 40 to attach the hanging strap 10 to the name plate 40. However, the mounting loop 11 of the hanging strap 10 has a fixed length so that the size of the mounting loop 11 of the hanging strap 10 cannot be adjusted to fit users of different statures. In addition, a user's neck is easily tangled with the mounting loop 11 of the hanging strap 10, thereby causing danger to the user.

### BRIEF SUMMARY OF THE INVENTION

In accordance with the present invention, there is provided a fastener in combination with a name plate and a hanging strap, comprising a fastener including a stop portion, at least one insertion portion mounted on the stop portion and provided with at least one clamping slot, and at least one recessed s retaining portion located between the stop portion and the at least one insertion portion, a name plate provided with two mounting holes spaced from each other and a mounting slot located between the two mounting holes, and a hanging strap having two distal ends.

The primary objective of the present invention is to provide a fastener that is combined with and detached from a name plate and a hanging strap easily and quickly.

Another objective of the present invention is to provide a fastener for a name plate, wherein the insertion portion of the fastener extends through each of the two mounting holes of the name plate to combine the fastener with the name plate, and each of the two distal ends of the hanging strap extends through the clamping slot of the insertion portion of the fastener to combine the fastener with the hanging strap, so that the fastener is combined with and detached from the name plate and the hanging strap easily and quickly.

A further objective of the present invention is to provide a fastener for a name plate, wherein the retaining portion of the fastener forms a first-stage limit portion to limit each of the two mounting holes of the name plate, and the clamping slot of the insertion portion of the fastener forms a second-stage limit portion to limit each of the two distal ends of the hanging strap so that the fastener provides a double-stage limit function.

A further objective of the present invention is to provide a fastener for a name plate, wherein each of the two distal ends of the hanging strap is movable in the clamping slot of the insertion portion of the fastener to adjust a distance between the hanging strap and the name plate to a proper extent so as to fit a user's stature and requirement.

A further objective of the present invention is to provide a fastener for a name plate, wherein when the name plate is pulled by an external force to an excessive extent, each of the two distal ends of the hanging strap is movable to detach from the clamping slot of the insertion portion of the fastener so as to detach the name plate from the hanging strap, thereby preventing the user's neck from being tangled with or hurt by the name plate and the hanging strap.

A further objective of the present invention is to provide a fastener for a name plate, wherein the insertion portion of the fastener is provided with a chamfered portion to facilitate insertion of the insertion portion into each of the two mounting holes of the name plate.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a fastener in accordance with the preferred embodiment of the present invention.

FIG. 2 is a side cross-sectional view of the fastener as shown in FIG. 1.

FIG. 3 is an exploded perspective view of the fastener for a name plate in accordance with the preferred embodiment of the present invention.

FIG. 4 is a partially perspective assembly view of the fastener for a name plate as shown in FIG. 3.

FIG. 5 is a rear assembly view of the fastener for a name plate as shown in FIG. 3.

FIG. 6 is a front assembly view of the fastener for a name plate as shown in FIG. 3.

FIG. 7 is a side assembly view of the fastener for a name plate as shown in FIG. 3.

FIG. 8 is a partially exploded perspective view of a fastener for a name plate in accordance with another preferred embodiment of the present invention.

FIG. 9 is a perspective assembly view of the fastener for a name plate as shown in FIG. 8.

FIG. 10 is a perspective view of a holder for a name plate as shown in FIG. 8.

FIG. 11 is a perspective view of the holder for a name plate as shown in FIG. 8.

FIG. 12 is a partially exploded perspective view of a fastener for a name plate in accordance with another preferred embodiment of the present invention.

FIG. 13 is a side cross-sectional assembly view of the fastener as shown in FIG. 12.

FIG. 14 is a perspective view of a fastener in accordance with another preferred embodiment of the present invention.

FIG. 15 is a top view of the fastener as shown in FIG. 14.

FIG. 16 is a perspective view of a fastener in accordance with another preferred embodiment of the present invention.

FIG. 17 is a side assembly view of the fastener as shown in FIG. 16.

FIG. 18 is an exploded perspective view of the fastener for a name plate in accordance with another preferred embodiment of the present invention.

FIG. 19 is a perspective assembly view of the fastener for a name plate as shown in FIG. 18.

FIG. 20 is a side assembly view of the fastener for a name plate as shown in FIG. 18.

FIG. 21 is a perspective view of a fastener in accordance with another preferred embodiment of the present invention.

FIG. 22 is a perspective view of a fastener in accordance with another preferred embodiment of the present invention.

FIG. 23 is a top assembly view of the fastener as shown in FIG. 22.

FIG. 24 is an exploded perspective view of the fastener for a name plate in accordance with another preferred embodiment of the present invention.

FIG. 25 is a perspective assembly view of the fastener for a name plate as shown in FIG. 24.

FIG. 26 is a perspective view of a conventional name plate assembly in accordance with the prior art.

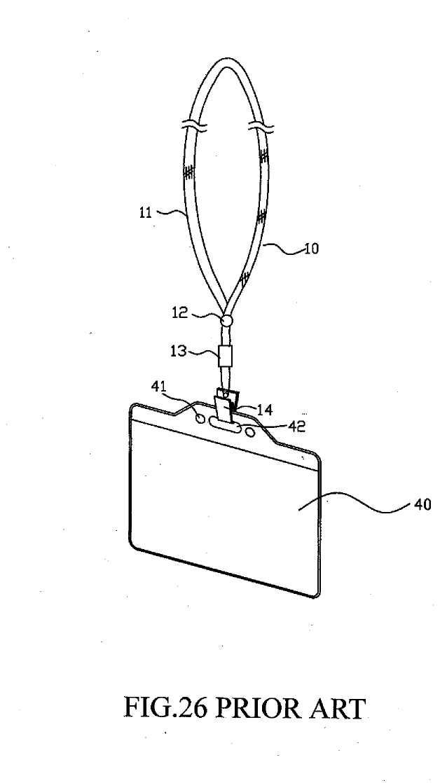

### DETAILED DESCRIPTION OF THE INVENTION

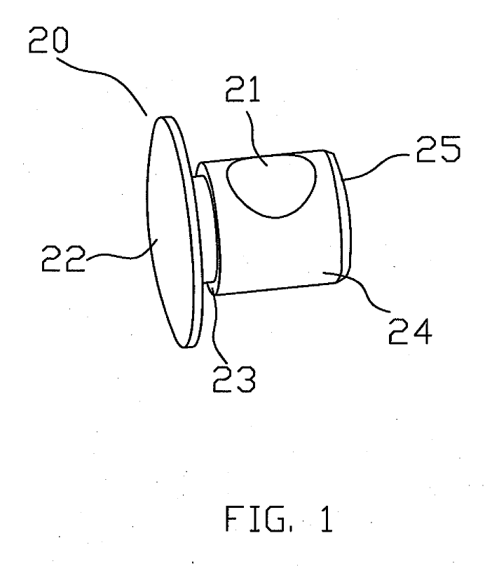

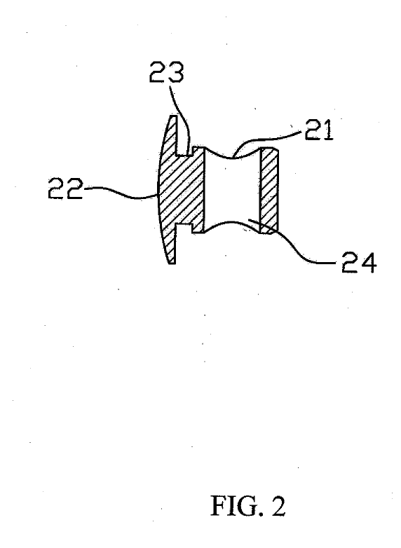

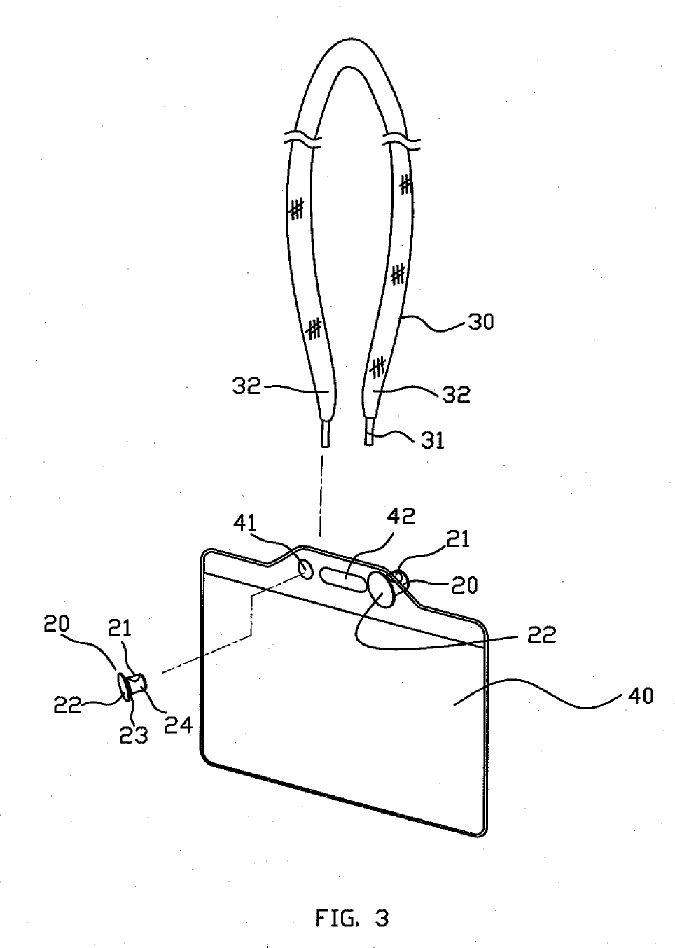

Referring to the drawings and initially to FIGS. 1-3, a fastener 20 in accordance with the preferred embodiment of the present invention comprises a stop portion 22, at least one insertion portion 24 mounted on the stop portion 22 and provided with at least one clamping slot 21, and at least one recessed retaining portion 23 located between the stop portion 22 and the at least one insertion portion 24.

The stop portion 22 has a substantially disk shape. The insertion portion 24 has a substantially cylindrical shape and has a size smaller than that of the stop portion 22. The insertion portion 24 has a first end mounted on the stop portion 22, a second end provided with a chamfered portion 25 and a middle portion provided with the clamping slot 21 which is located between the stop portion 22 and the chamfered portion 25. The clamping slot 21 of the insertion portion 24 extends transversely through a whole thickness of the insertion portion 24. The retaining portion 23 is located between the stop portion 22 and the clamping slot 21 of the insertion portion 24.

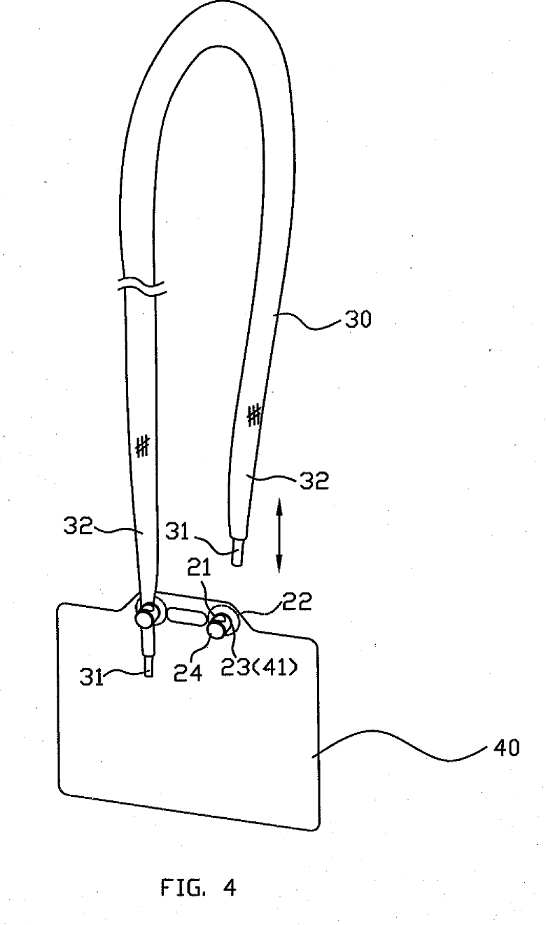

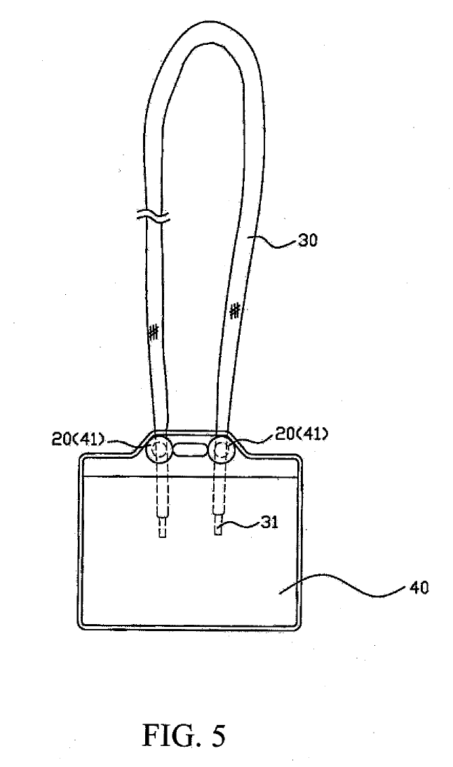

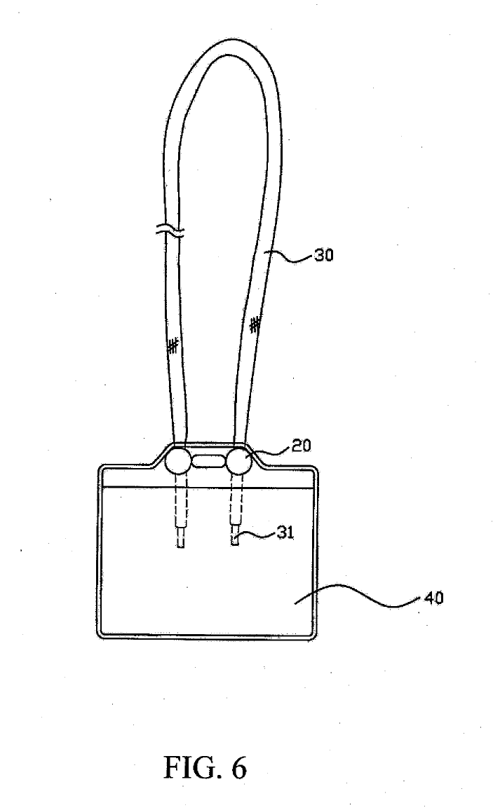

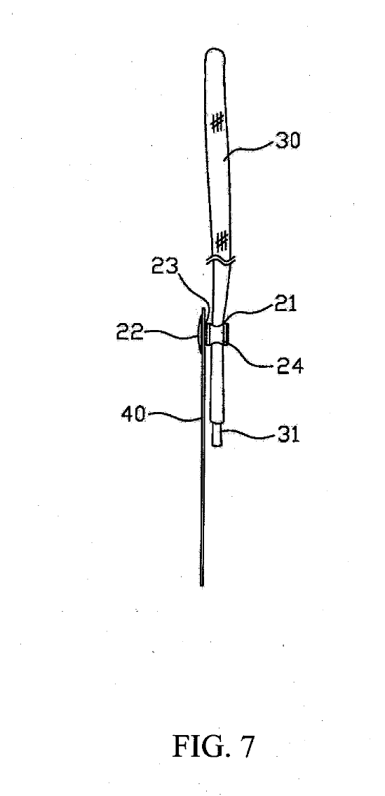

Referring to FIGS. 1-7, the fastener 20 is available for a name plate 40 and a hanging strap 30. The name plate 40 is provided with two mounting holes 41 spaced from each other and a mounting slot 42 located between the two mounting holes 41. Each of the two mounting holes 41 of the name plate 40 has a size equal to that of the insertion portion 24 of the fastener 20 and smaller than that of the stop portion 22 of the fastener 20. The hanging strap 30 has two distal ends 32 each provided with a reduced portion 31. The hanging strap 30 is made of a flexible and resilient material and has a size greater than that of the clamping slot 21 of the insertion portion 24.

In assembly, the insertion portion 24 of the fastener 20 (preferably two fasteners 20) extends through each of the two mounting holes 41 of the name plate 40, the stop portion 22 of the fastener 20 abuts a first side of the name plate 40, and the clamping slot 21 of the insertion portion 24 protrudes outwardly from a second side of the name plate 40. At this time, each of the two mounting holes 41 of the name plate 40 has a peripheral wall inserted into and locked in the retaining portion 23 of the fastener 20. Then, each of the two distal ends 32 of the hanging strap 30 extends through and is clamped in the clamping slot 21 of the insertion portion 24 of the fastener 20 with the reduced portion 31 protruding outwardly from the clamping slot 21 to attach the hanging strap 30 to the fastener 20.

Accordingly, the insertion portion 24 of the fastener 20 extends through each of the two mounting holes 41 of the name plate 40 to combine the fastener 20 with the name plate 40, and each of the two distal ends 32 of the hanging strap 30 extends through the clamping slot 21 of the insertion portion 24 of the fastener 20 to combine the fastener 20 with the hanging strap 30, so that the fastener 20 is combined with and detached from the name plate 40 and the hanging strap 30 easily and quickly. In addition, the retaining portion 23 of the fastener 20 forms a first-stage limit portion to limit each of the two mounting holes 41 of the name plate 40, and the clamping slot 21 of the insertion portion 24 of the fastener 20 forms a second-stage limit portion to limit each of the two distal ends 32 of the hanging strap 30 so that the fastener 20 provides a double-stage limit function. Further, each of the two distal ends 32 of the hanging strap 30 is movable in the clamping slot 21 of the insertion portion 24 of the fastener 20 to adjust a distance between the hanging strap 30 and the name plate 40 to a proper extent so as to fit a user's stature and requirement. Further, when the name plate 40 is pulled by an external force to an excessive extent, each of the two distal ends 32 of the hanging strap 30 is movable to detach from the clamping slot 21 of the insertion portion 24 of the fastener 20 so as to detach the name plate 40 from the hanging strap 30, thereby preventing the user's neck from being tangled with or hurt by the name plate 40 and the hanging strap 30. Further, the insertion portion 24 of the fastener 20 is provided with a chamfered portion 25 to facilitate insertion of the insertion portion 24 into each of the two mounting holes 41 of the name plate 40.

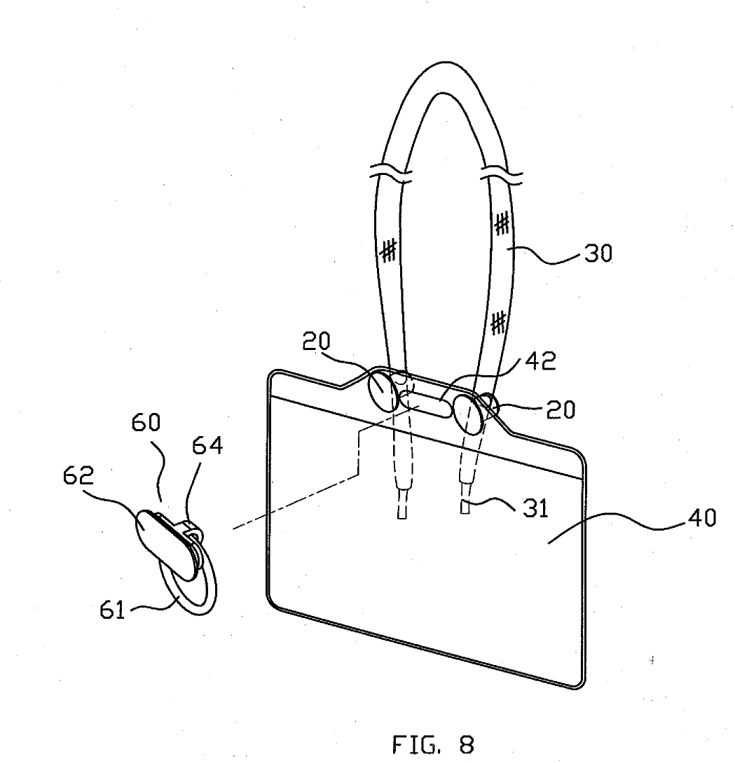

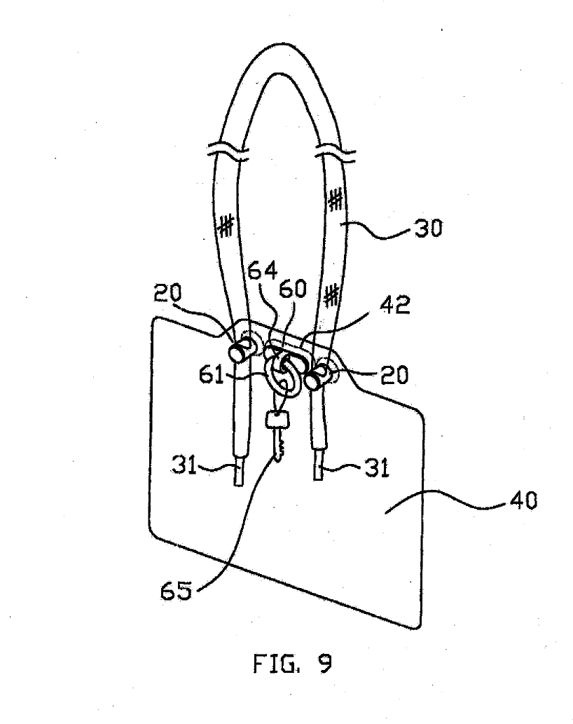

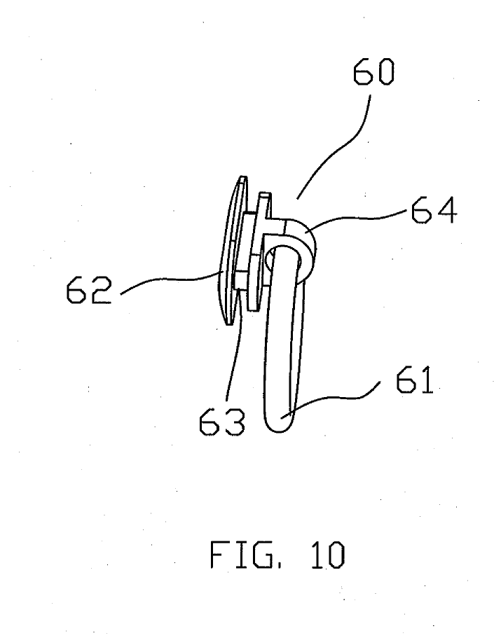

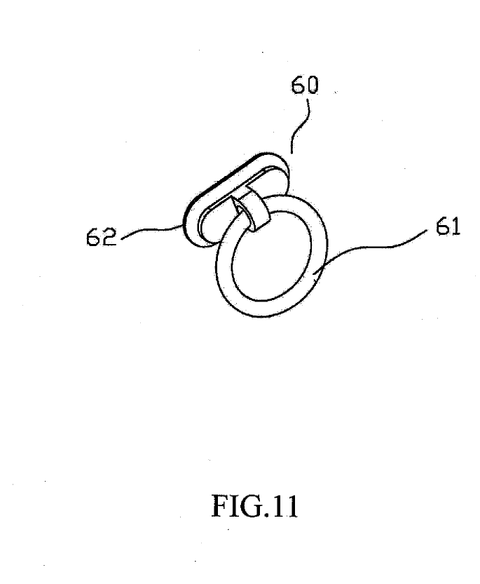

Referring to FIGS. 8-11, a holder 60 in accordance with the preferred embodiment of the present invention comprises a stop section 62 abutting the first side of the name plate 40, an insertion section 64 mounted on the stop section 62 and extending through the mounting slot 42 of the name plate 40, a hanging ring 61 pivotally mounted on the insertion section 64 and protruding outwardly from the second side of the name plate 40 for hanging a tiny item 65, such as a key and the like, and a recessed retaining section 63 located between the stop section 62 and the insertion section 64 and locked onto a peripheral wall of the mounting slot 42 of the name plate 40.

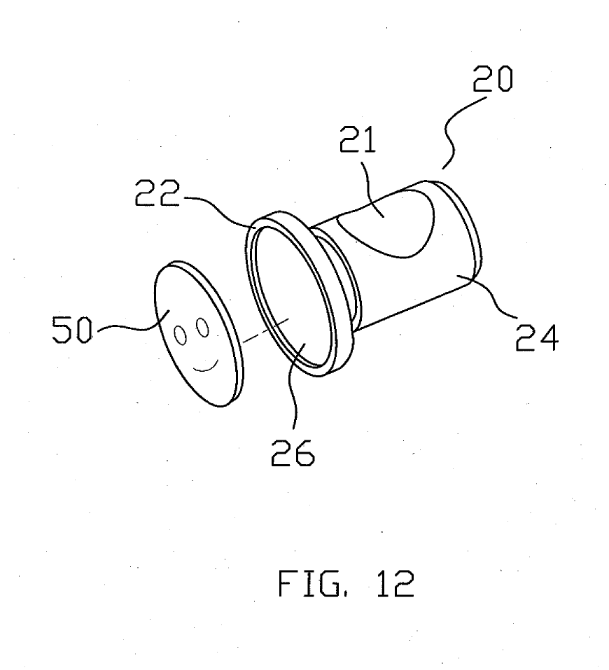

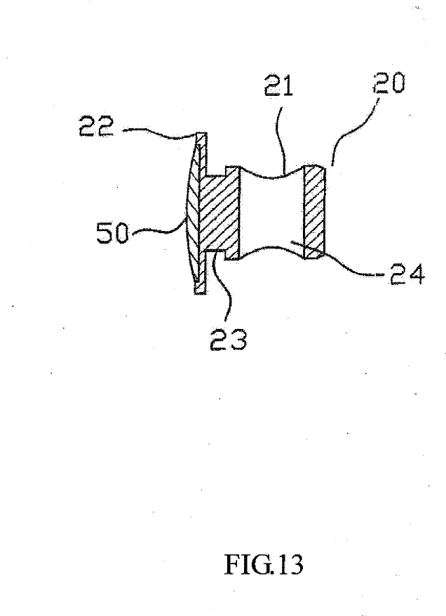

Referring to FIGS. 12 and 13, the stop portion 22 of the fastener 20 has a face provided with a mounting recess 26 for mounting a patterned cover 50.

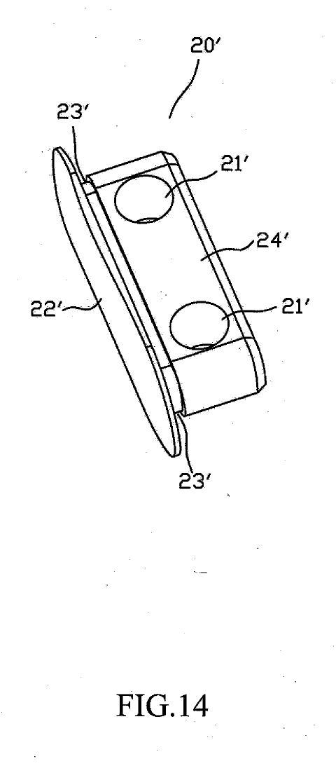

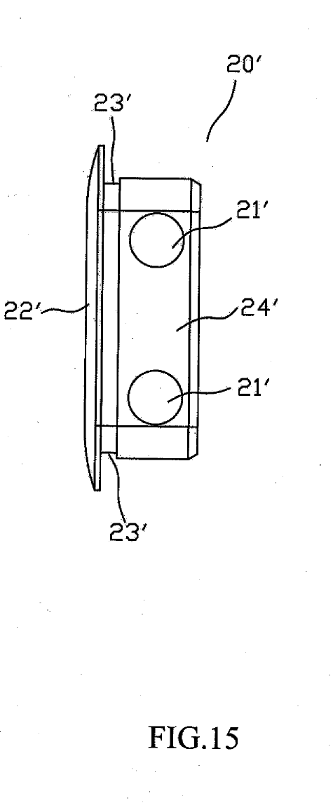

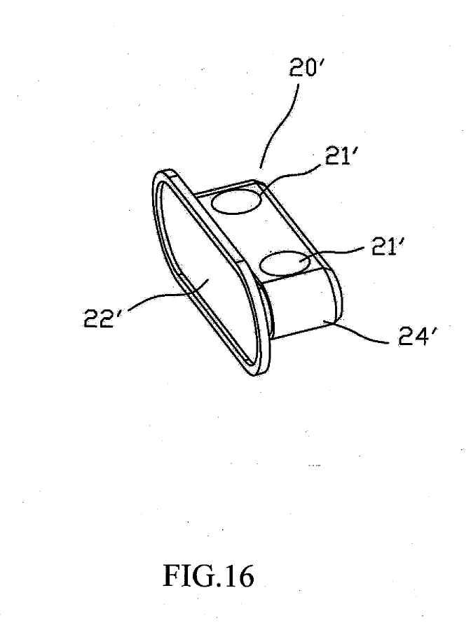

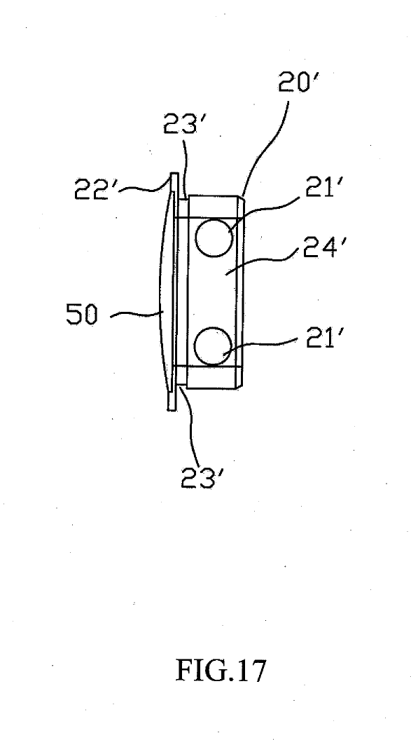

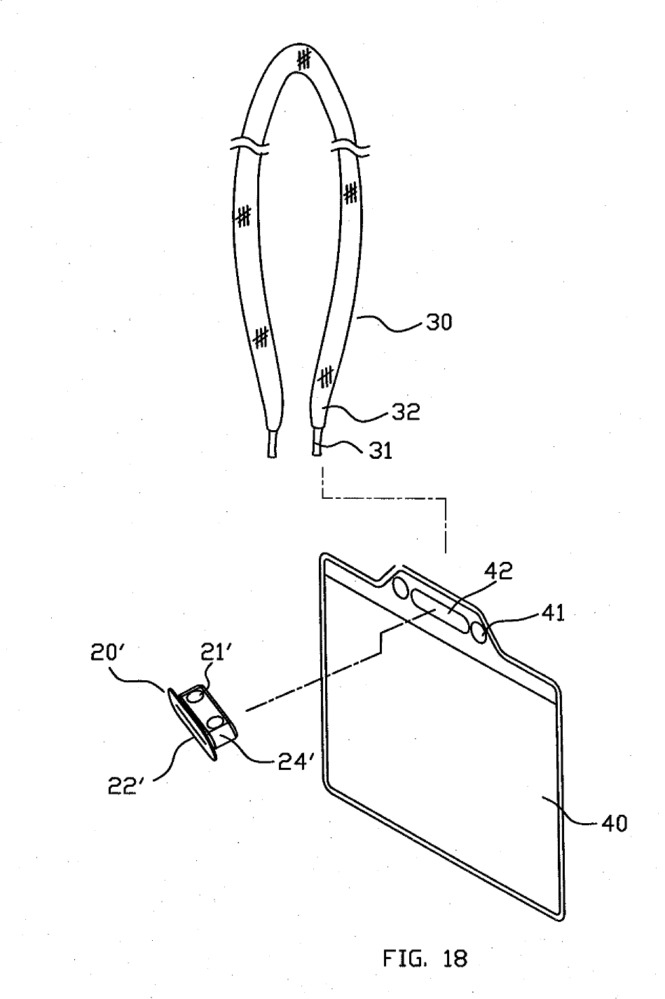

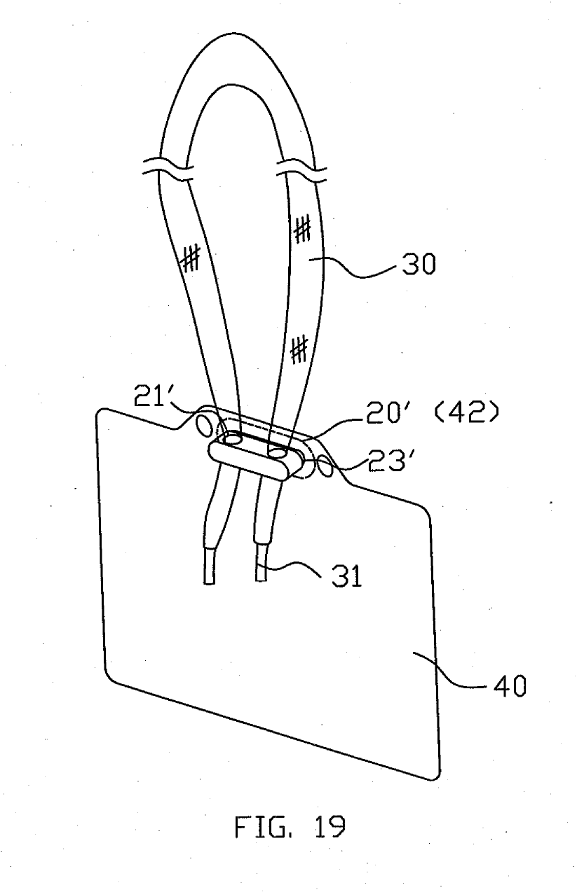

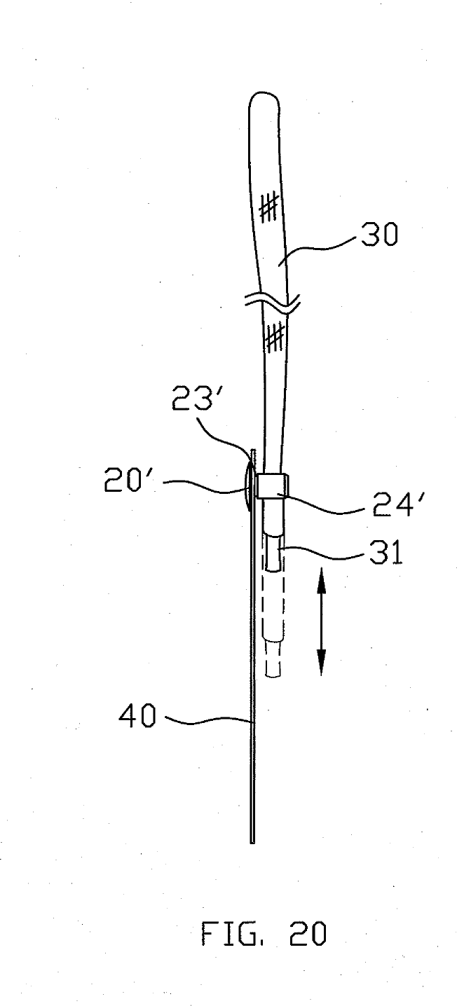

Referring to FIGS. 14-20, the fastener 20′ comprises a stop portion 22′, an insertion portion 24′ mounted on the stop portion 22′ and provided with two clamping slots 21′, and a recessed retaining portion 23′ located between the stop portion 22′ and the insertion portion 24′. In assembly, the insertion portion 24′ of the fastener 20′ extends through the mounting slot 42 of the name plate 40, the stop portion 22′ of the fastener 20′ abuts the first side of the name plate 40′, and the clamping slots 21′ of the insertion portion 24′ protrudes outwardly from the second side of the name plate 40. At this time, the mounting slot 42 of the name plate 40 has a peripheral wall inserted into and locked in the retaining portion 23′ of the fastener 20′. Then, each of the two distal ends 32 of the hanging strap 30 extends through and is clamped in the respective clamping slot 21′ of the insertion portion 24′ of the fastener 20′ with the reduced portion 31 protruding outwardly from the respective clamping slot 21′ to attach the hanging strap 30 to the fastener 20′.

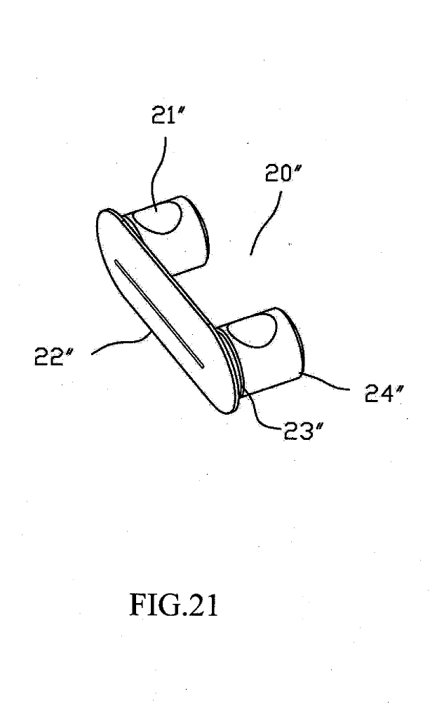

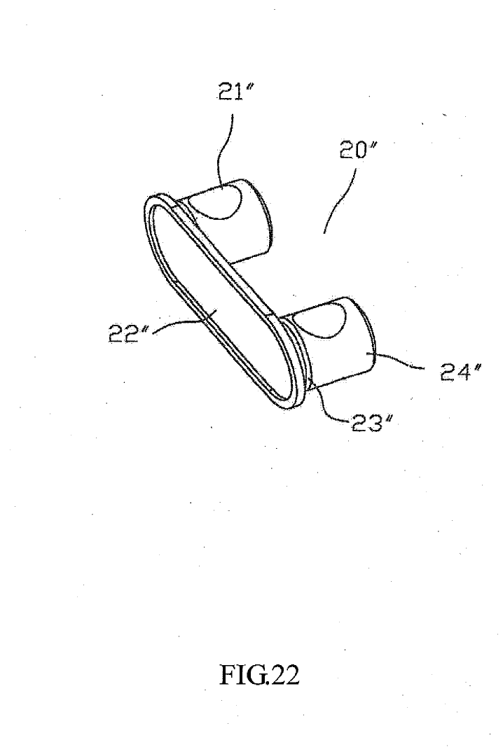

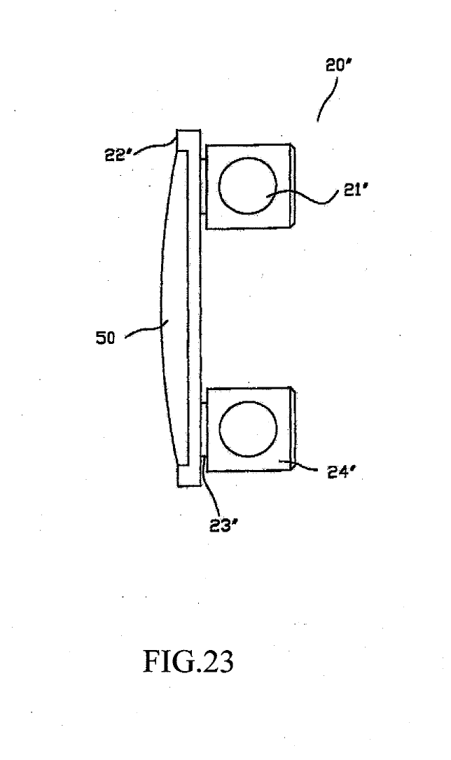

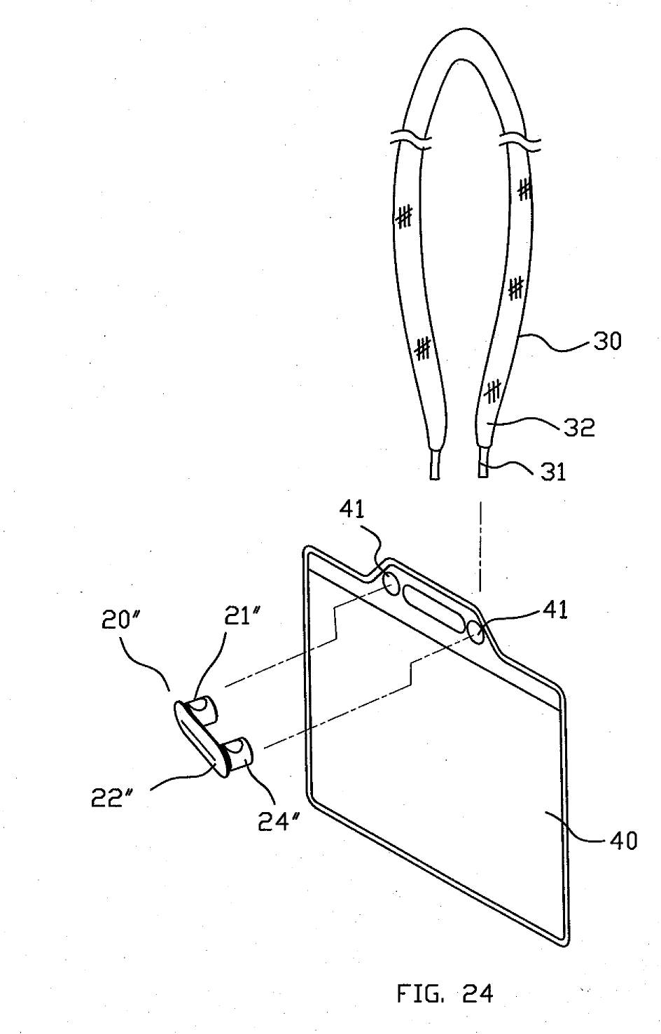

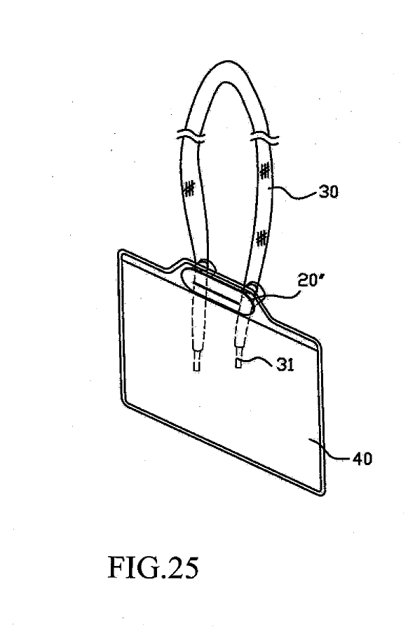

Referring to FIGS. 21-25, the fastener 20″ comprises a stop portion 22″, two spaced insertion portions 24″ mounted on the stop portion 22″ respectively and each provided with a clamping slot 21″, and two recessed retaining portions 23″ each located between the stop portion 22″ and the respective insertion portion 24″. In assembly, each of the insertion portions 24″ of the fastener 20″ extends through the respective mounting hole 41 of the name plate 40, the stop portion 22″ of the fastener 20″ abuts the first side of the name plate 40″, and the clamping slot 21″ of each of the insertion portions 24″ protrudes outwardly from the second side of the name plate 40. At this time, each of the mounting holes 41 of the name plate 40 has a peripheral wall inserted into and locked in the respective retaining portion 23″ of the fastener 20″. Then, each of the two distal ends 32 of the hanging strap 30 extends through and is clamped in the clamping slot 21″ of the respective insertion portion 24″ of the fastener 20″ with the reduced portion 31 protruding outwardly from the clamping slot 21″ to attach the hanging strap 30 to the fastener 20″.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A fastener in combination with a name plate and a hanging strap, comprising:
a fastener including a stop portion, at least one insertion portion mounted on the stop portion and provided with at least one clamping slot, and at least one recessed retaining portion located between the stop portion and the at least one insertion portion;
a name plate provided with two mounting holes spaced from each other and a mounting slot located between the two mounting holes;
a hanging strap having two distal ends.

2. The fastener in combination with a name plate and a hanging strap in accordance with claim 1, wherein
the insertion portion of the fastener extends through each of the two mounting holes of the name plate;
the stop portion of the fastener abuts a first side of the name plate;
the clamping slot of the insertion portion protrudes outwardly from a second side of the name plate;
each of the two distal ends of the hanging strap extends through and is clamped in the clamping slot of the insertion portion of the fastener.

3. The fastener in combination with a name plate and a hanging strap in accordance with claim 2, wherein each of the two mounting holes of the name plate has a peripheral wall inserted into and locked in the retaining portion of the fastener.

4. The fastener in combination with a name plate and a hanging strap in accordance with claim 1, wherein the insertion portion has a first end mounted on the stop portion, a second end provided with a chamfered portion and a middle portion provided with the clamping slot.

5. The fastener in combination with a name plate and a hanging strap in accordance with claim 4, wherein the clamping slot of the insertion portion is located between the stop portion and the chamfered portion.

6. The fastener in combination with a name plate and a hanging strap in accordance with claim 1, further comprising:
a holder including a stop section abutting a first side of the name plate, an insertion section mounted on the stop section and extending through the mounting slot of the name plate, a hanging ring pivotally mounted on the insertion section and protruding outwardly from a second side of the name plate, and a recessed retaining section located between the stop section and the insertion section and locked onto a peripheral wall of the mounting slot of the name plate.

7. The fastener in combination with a name plate and a hanging strap in accordance with claim 1, wherein the stop portion of the fastener has a face provided with a mounting recess for mounting a patterned cover.

8. The fastener in combination with a name plate and a hanging strap in accordance with claim 1, wherein
the insertion portion of the fastener is provided with two clamping slots;
the insertion portion of the fastener extends through the mounting slot of the name plate;
the stop portion of the fastener abuts a first side of the name plate;
the clamping slots of the insertion portion protrudes outwardly from a second side of the name plate;
each of the two distal ends of the hanging strap extends through and is clamped in the respective clamping slot of the insertion portion of the fastener.

9. The fastener in combination with a name plate and a hanging strap in accordance with claim 8, wherein the mounting slot of the name plate has a peripheral wall inserted into and locked in the retaining portion of the fastener.

10. The fastener in combination with a name plate and a hanging strap in accordance with claim 1, wherein
the fastener includes two spaced insertion portions mounted on the stop portion respectively and each provided with a clamping slot and two recessed retaining portions each located between the stop portion and the respective insertion portion;
each of the insertion portions of the fastener extends through the respective mounting hole of the name plate;
the stop portion of the fastener abuts a first side of the name plate;
the clamping slot of each of the insertion portions protrudes outwardly from the second side of the name plate;
each of the two distal ends of the hanging strap extends through and is clamped in the clamping slot of the respective insertion portion of the fastener.

11. The fastener in combination with a name plate and a hanging strap in accordance with claim 10, wherein the each of the mounting holes of the name plate has a peripheral wall inserted into and locked in the respective retaining portion of the fastener.

12. The fastener in combination with a name plate and a hanging strap in accordance with claim 1, wherein the insertion portion has a size smaller than that of the stop portion.

13. The fastener in combination with a name plate and a hanging strap in accordance with claim 1, wherein the retaining portion is located between the stop portion and the clamping slot of the insertion portion.

14. The fastener in combination with a name plate and a hanging strap in accordance with claim 2, wherein each of the two mounting holes of the name plate has a size equal to that of the insertion portion of the fastener and smaller than that of the stop portion of the fastener.

15. The fastener in combination with a name plate and a hanging strap in accordance with claim 1, wherein the hanging strap is made of a flexible and resilient material and has a size greater than that of the clamping slot of the insertion portion.

16. The fastener in combination with a name plate and a hanging strap in accordance with claim 1, wherein each of the two distal ends of the hanging strap is movable in the clamping slot of the insertion portion of the fastener.

17. The fastener in combination with a name plate and a hanging strap in accordance with claim 1, wherein the clamping slot of the insertion portion extends transversely through a whole thickness of the insertion portion.
